(19) United States
(12) Patent Application Publication
(10) Pub. No.: US 2026/0264580 A1
(43) Pub. Date: Sep. 10, 2026

(54) RECLINING DEVICE AND SEAT

(71) Applicant: DELTA KOGYO CO., LTD., Hiroshima (JP)

(72) Inventor: Shogo MASUMURA, Hiroshima (JP)

(73) Assignee: DELTA KOGYO CO., LTD., Hiroshima (JP)

(21) Appl. No.: 19/473,801

(22) PCT Filed: Mar. 26, 2024
(86) PCT No.: PCT/JP2024/012102

§ 371 Date: Oct. 8, 2025

(30) Foreign Application Priority Data
Apr. 27, 2023 (JP) 2023-073314

(51) Int. Cl. B60N 2/235

(52) U.S. Cl. CPC B60N 2/236

(57) ABSTRACT

A reclining device includes: lock gears each to mesh with an internal tooth of an internal gear; a cam configured to radially move each lock gear; a guide bracket having guide walls configured to radially guide the lock gear; and a wedge interposed between the cam and the lock gear and pressing the lock gear. The cam has: a pushing face (wedge pushing part) configured to push the wedge radially outward while maintaining a state of contact with the wedge during movement of the lock gear from a release position to a meshing position; and a bulge that faces the lock gear while keeping a gap between the bulge and the lock gear during the movement of the lock gear from the release position to the meshing position.

### TECHNICAL FIELD

The present invention relates to a reclining device, and a seat including the reclining device.

### BACKGROUND ART

Conventional seats for vehicles include a seat that comprises a reclining device to fixedly hold a seatback (backrest) at a certain tilt angle, the seatback being configured to be tiltable relative to a seat cushion (seat base) in a front-rear direction.

For instance, as illustrated in FIG. 15, a reclining device 70 described in Patent Literature 1 includes a guide bracket 72, an internal gear 76 having a plurality of internal teeth 76a, three lock gears 180 (pawls), a cam 90, and three pressing members 100.

The guide bracket 72 is a substantially circular plate member fixedly attached to a frame of a seat cushion, and has three pairs of guide walls 73, 74 that radially extend. The three pairs of guide walls 73, 74 are spaced from one another in a circumferential direction of the guide bracket 72.

The internal gear 76 is a member having a ring portion fixedly attached to a seatback, and has internal teeth 76a provided over an inner circumferential surface thereof.

Each of the three lock gears 180 has a plurality of external teeth 82, each tooth configured to mesh with the associated internal tooth 76a of the internal gear 76, and has a pair of widthwise ends 81 respectively being in contact with the associated guide walls 73, 74. The three lock gears 180 are spaced from one another in a circumferential direction of the internal gear 76, and are each radially movable along the guide walls 73, 74 extending radially over a region between a meshing position where the external tooth 82 and the internal tooth 76a mesh and a release position where the meshing is released.

Besides, each of the three lock gears 180 has the external teeth 82, and a cam facing part 83 located at a radially inner position that is opposite to the external teeth 82 so as to face the cam 90. The cam facing part 83 has a protrusion 83a and an L-shaped hook 83b spaced from each other in the circumferential direction.

The cam 90 is rotatable relative to the guide bracket 72 between a predetermined locking angle and an unlocking angle, and is configured to radially move each of the three lock gears 180 from the release position to the meshing position by rotating from the unlocking angle to the locking angle.

The cam 90 has a main body 91 in a circular plate shape, three sets of L-shaped hooks 92 and shoulders 93 respectively facing the three lock gears 180 and protruding from the main body 91 radially outward. Each hook 92 engages with the hook 83b of the associated lock gear 180 when the cam 90 is at the unlocking angle. Each shoulder 93 is configured to push the lock gear 180 radially outward while always being in contact with an outer circumferential face of the hook 83b of the lock gear 180 during rotation of the cam 90 from the unlocking angle to the locking angle (in a locking direction R).

Each of the three pressing members 100 is surrounded by the associated guide wall 74, the protrusion 83a of the associated lock gear 180, and the cam 90. The pressing member 100 is pushed by an outer circumferential face of the hook 92 of the cam 90 to move outward in a radial direction of the cam 90 along the guide wall 74 during the rotation of the cam 90 from the unlocking angle to the locking angle. In this manner, the pressing member 100 presses the lock gear 180 radially outward by applying a pressing force to the protrusion 83a of the lock gear 180 radially outward and in an inclined direction with respect to the circumferential direction.

That is to say, in the reclining device 70, the shoulder 93 of the cam 90 pushes the lock gear 180 radially outward and the outer circumferential face of the hook 92 of the cam 90 pushes the pressing member 100 radially outward to move the lock gear 180 radially outward to the meshing position (i.e., a position where the external tooth 82 and the internal tooth 76a mesh) during the rotation of the cam 90 from the unlocking angle to the locking angle (in the locking direction R).

It is noted here that a clearance is made between each of the widthwise ends 81 being the opposite ends of the lock gear 180 in a width direction thereof and each of the guide walls 73, 74 of the guide bracket 72 to allow the lock gear 180 to smoothly slide. In the conventional reclining device 70 illustrated in FIG. 15, when the cam 90 precedingly pushes the lock gear 180 to move the lock gear 180 radially outward toward the meshing position, the pressing member 100 tilts due to the existence of the clearance. Such tilting may make the posture of the lock gear unstable, resulting in a concern that the reclining device is placed in an incomplete locking or half-locking state.

Further, the external teeth 82 of the lock gear 180 may mesh with the internal teeth 76a of the internal gear 76 at the meshing position before the pressing member 100 pushes in the lock gear 180 due to variation in the components including the lock gear 180, and the lock gear 180 may rattle in the locking state.

### CITATION LIST

### Patent Literature

Patent Literature 1: Japanese Patent Publication No. 5434969

### SUMMARY OF INVENTION

The present invention has been accomplished in view of the circumstances described above, and has an object of providing a reclining device that achieves prevention of rattling of a lock gear in a locking state while stabilizing a posture of the lock gear during the movement.

A reclining device according to the present invention includes: a guide bracket configured to be fixedly attached to one of a frame of a seat cushion and a frame of a seatback; an internal gear configured to be fixedly attached to the other of the frame of the seat cushion and the frame of the seatback in such a manner as to face the guide bracket and be rotatable relative to the guide bracket; a plurality of lock gears each having a plurality of external teeth configured to mesh with a plurality of internal teeth of the internal gear, spaced from each other in a circumferential direction of the internal gear, and each being movable along the guide bracket in a radial direction of the guide bracket over a region between a meshing position where the external teeth and the internal teeth mesh and a release position where the meshing is released; a cam that is rotatable relative to the guide bracket between a predetermined locking angle and an unlocking angle, and configured to radially move each of the lock gears from the release position to the meshing position by rotating from the unlocking angle to the locking angle; a lock spring that rotates and urges the cam from the unlocking angle to the locking angle; and a wedge interposed between at least one lock gear among the lock gears and the cam and pressing the lock gear. The guide bracket has a plurality of pairs of guide walls facing each other and configured to radially guide the lock gears. At least one of the lock gears pressed by the wedge has a wedge contact face extending in an inclined direction with respect to the radial direction and being in contact with the wedge. The wedge is sandwiched between the wedge contact face and an associated guide wall among the guide walls. The cam has: a wedge pushing part configured to push the wedge radially outward while maintaining a state of contact with the wedge during movement of the lock gear from the release position to the meshing position; and a lock gear facing part that faces the lock gear while keeping a gap between the lock gear facing part and the lock gear pressed by the wedge during the movement of the lock gear from the release position to the meshing position.

### BRIEF DESCRIPTION OF DRAWINGS

FIG. 1 is a perspective view illustrating an overall configuration of a seat including a reclining device according to an embodiment of the present invention.

FIG. 2 is a perspective view illustrating a disassembled state of a connecting rod and a reclining mechanism in FIG. 1.

FIG. 3 is an exploded perspective view of the reclining mechanism in FIG. 2.

FIG. 4 is a perspective view of a cam in FIG. 3.

FIG. 5 is an illustration of a guide bracket in FIG. 3 seen from an outer surface of the guide bracket.

FIG. 6A is an illustration of a completed state of the reclining mechanism including an internal gear, a pair of main lock gears, a pair of sub-lock gears, a pair of wedges, the cam, the guide bracket, and an attachment ring in FIG. 3 in combination in an axial view from an outside of the attachment ring.

FIG. 6B is an illustration of the completed state of the reclining mechanism including the internal gear, the pair of main lock gears, the pair of sub-lock gears, the pair of wedges, the cam, the guide bracket, and the attachment ring in FIG. 3 in combination in a cross-sectional view taken along the line A-A in FIG. 6A.

FIG. 7 is an illustration of an arrangement of the cam, the pair of main lock gears, the pair of sub-lock gears, the pair of wedges, and the internal gear each illustrated in FIG. 3.

FIG. 8 is an enlarged view of a state where the upper main lock gear in FIG. 7 is at a meshing position, the main lock gear is away from the cam, and the wedge is in contact with the cam.

FIG. 9 is an illustration of locations of the upper main lock gear in FIG. 7, the wedge, and the cam in a state where the main lock gear is at a release position.

FIG. 10 is an illustration of locations of the upper main lock gear in FIG. 7, the wedge, and the cam during movement of the main lock gear from the release position to the meshing position.

FIG. 11 is an illustration of locations of the upper main lock gear in FIG. 7, the wedge, and the cam during the movement of the main lock gear from the release position to the meshing position.

FIG. 12 is an illustration of locations of the upper main lock gear in FIG. 7, the wedge, and the cam during the movement of the main lock gear from the release position to the meshing position.

FIG. 13 is an illustration of locations of the upper main lock gear in FIG. 7, the wedge, and the cam in a state where the main lock gear is at the meshing position.

FIG. 14 is an illustration of a state where each of the pair of main lock gears and the pair of sub-lock gears in FIG. 7 is at the meshing position.

FIG. 15 is a cross-sectional view of a structure of a conventional reclining device.

### DESCRIPTION OF EMBODIMENTS

Hereinafter, a preferable embodiment of the present invention will be described with reference to the accompanying drawings.

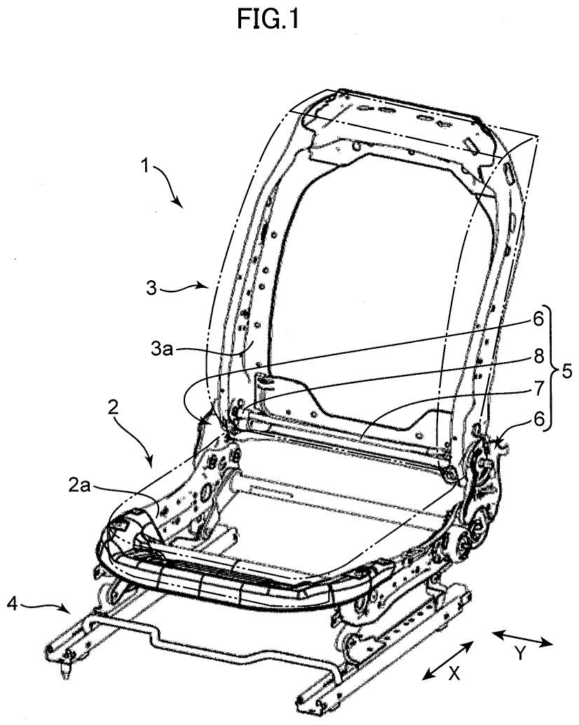

As illustrated in FIG. 1, a seat 1 according to the embodiment is a vehicle seat, which includes: a seat cushion 2 for supporting buttocks of an occupant; a seatback 3 located in the rear of the seat cushion 2 to support the back of the occupant and being tiltable to the seat cushion 2 in a front-rear direction X of the seat 1; a sliding device 4 attached to a lower portion of the seat cushion 2; and a reclining device 5.

The sliding device 4 is configured to guide the seat cushion 2 slidably in the front-rear direction X of the seat 1, and fixedly hold the seat cushion 2 at a certain position. Here, the seat according to the present invention may not indispensably include the sliding device 4.

The reclining device 5 includes, as a main structure, a reclining mechanism 6 configured to fixedly hold the seatback 3 at a certain tilt angle.

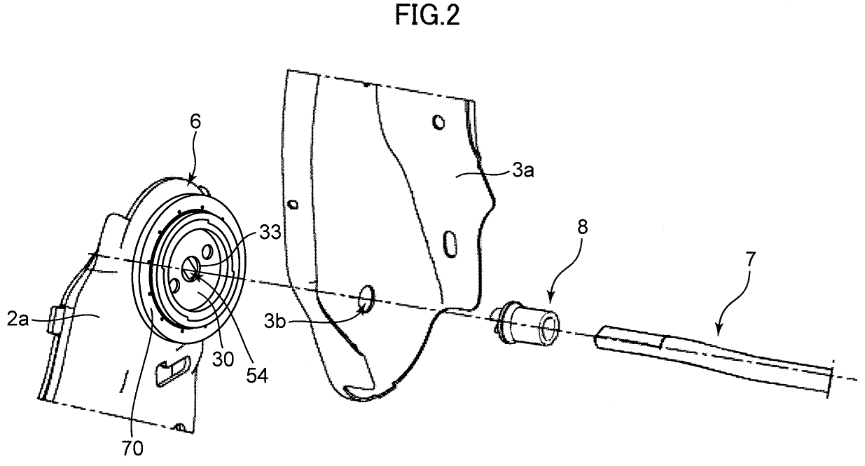

Specifically, as illustrated in FIG. 1 and FIG. 2, the reclining device 5 according to the embodiment includes: a pair of reclining mechanisms 6; a connecting rod 7 connected to each of the reclining mechanisms 6; and a pair of resin bushes 8 to each receive corresponding one of opposite ends of the connecting rod 7. The resin bushes 8 may be excluded.

The two reclining mechanisms 6 are arranged respectively on both sides of the seat 1 in a width direction Y thereof. Each of the reclining mechanisms 6 serves as a clutch to fixedly hold the seatback 3 at a certain tilt angle.

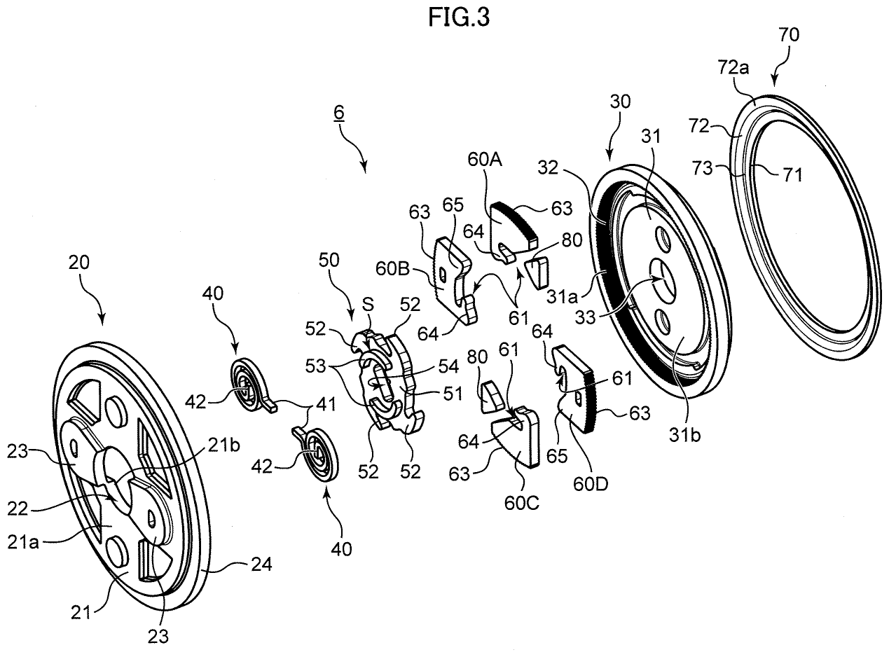

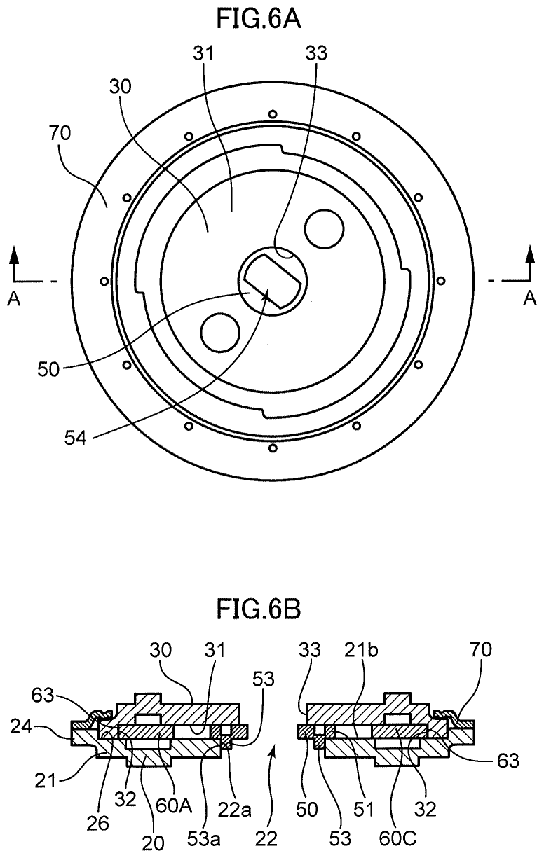

As illustrated in FIG. 3, FIG. 6A, and FIG. 6B, the reclining mechanism 6 includes a guide bracket 20 in a circular plate shape, an internal gear 30, a pair of main lock gears 60A, 60C and a pair of sub-lock gears 60B, 60D, a cam 50, two lock springs 40, a pair of wedges 80, and an attachment ring 70. The internal gear 30 is arranged to face the guide bracket 20, and has a plurality of internal teeth 32. The pair of main lock gears 60A, 60C and the pair of sub-lock gears 60B, 60D are four lock gears 60A to 60D each having a plurality of external teeth 63 to mesh with associated internal teeth 32. The cam 50 is configured to move each of the four lock gears 60A to 60D in a radial direction of the guide bracket 20. The two lock springs 40 rotate and urge the cam 50. Although the two lock springs 40 are adopted in the embodiment, at least one lock spring may be sufficient. Each of the two wedges 80 may be interposed between at least one lock gear among the four lock gears 60A to 60D, specifically, in the embodiment between corresponding one of the two main lock gears 60A, 60C, and the cam 50 to press the corresponding one of the main lock gears 60A, 60C. The attachment ring 70 attaches the internal gear 30 to the guide bracket 20. The four lock gears 60A to 60D, the cam 50, the pair of wedges 80, and the two lock springs 40 are located between the guide bracket 20 and the internal gear 30.

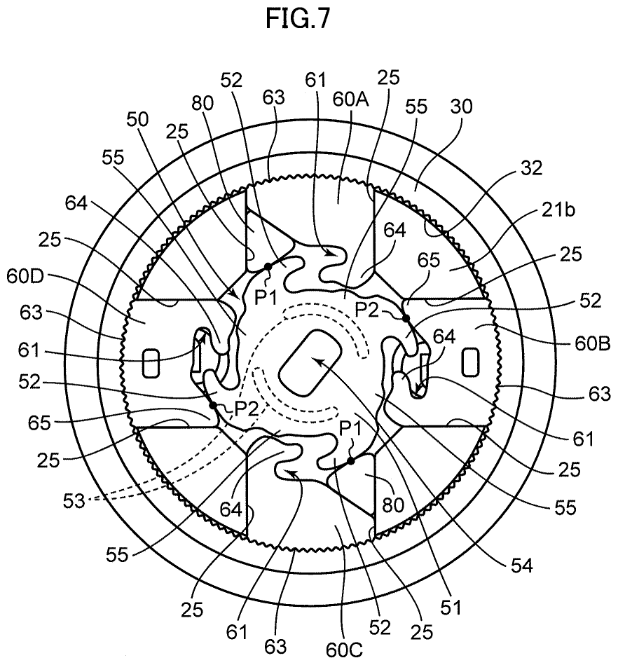

As illustrated in FIG. 7, the four lock gears 60A to 60D, that is, the pair of main lock gears 60A, 60C and the pair of sub-lock gears 60B, 60D, are spaced from one another in a circumferential direction of the internal gear 30, each of the lock gears being movable along the guide bracket 20 in a radial direction of the guide bracket 20 over a region between a meshing position where the external teeth 63 of each lock gear and the associated internal teeth 32 of the internal gear 30 mesh and a release position where the meshing is released. Specifically, each of the main lock gears 60A, 60C has the external teeth 63 configured to mesh with the associated internal teeth 32, and achieves firm meshing in response to pushing by the cam 50 via the associated wedge 80. In contrast, each of the sub-lock gears 60B, 60D has the external teeth 63 configured to mesh with the associated internal teeth 32, and such meshing with the internal teeth 32 intends to supplement the firm meshing (locking strength) of the main lock gears 60A, 60C. In the embodiment, a small spiral spring is adopted for each lock spring 40.

Here, the “firm meshing” of the main lock gear 60A, 60C means meshing of the external teeth 63 and the corresponding internal teeth 32 with their individual tooth faces being in pressing contact with each other. In contrast, the sub-lock gear 60B, 60D does not need such firm meshing as the meshing of the main lock gear 60A, 60C that the external teeth 63 thereof and the associated internal teeth 32 press each other, but only requires meshing to supplement the firm meshing (locking strength) of the main lock gear 60A, 60C. Therefore, examples of the meshing of the external teeth 63 of the sub-lock gear 60B, 60D with the associated internal teeth 32 may include a state of weak meshing where the tooth face of the external teeth and the tooth face of the internal teeth are partially in contact with each other or slightly spaced from each other.

The guide bracket 20 is a plate member having a center hole 22 in a circular shape at the center thereof. The guide bracket 20 in the embodiment is configured to be fixedly attached to a portion around the rear of a frame 2a (specifically, a side frame, see FIG. 1 to FIG. 2) of the seat cushion 2 serving as one of a frame of the seat cushion 2 and a frame of the seatback 3.

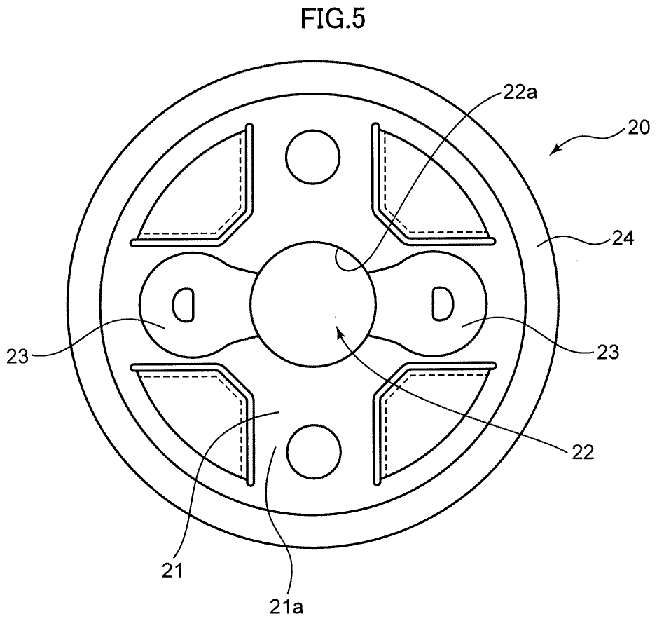

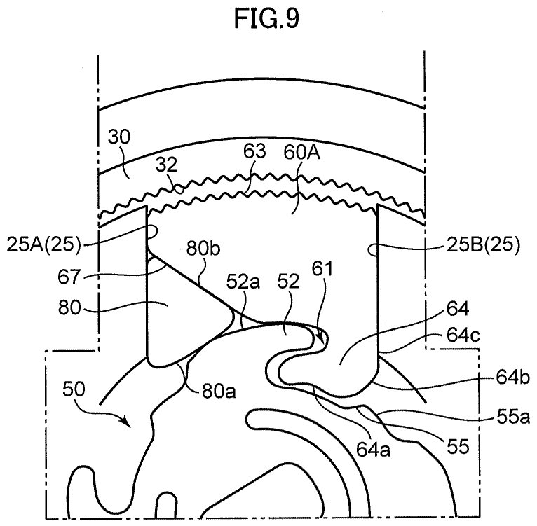

Specifically, as illustrated in FIG. 3, FIG. 5, FIG. 6B, and FIG. 9, the guide bracket 20 includes: a main body 21 having a disc shape and having the center hole 22 in the circular shape at the center thereof; two accommodation parts 23 respectively accommodating the lock springs 40; and a flange 24 extending along an outer circumference of the main body 21.

Each of the two accommodation parts 23 is recessed toward an outer surface 21a of the guide bracket 20, opens to an inner surface 21b of the main body 21, and communicates with the center hole 22. This configuration allows an outer end 41 of the lock spring 40 to protrude to an inner position of the center hole 22 with a swirl portion of the lock spring 40 accommodated in the accommodation part 23.

As illustrated in FIG. 6B and FIG. 7, the guide bracket 20 further includes a plurality of guide walls 25 (guide parts) configured to guide the four lock gears 60A to 60D respectively in radial directions of the guide bracket 20 on the inner surface 21b (the facing surface) of the main body 21. The guide walls 25 are arranged at equal intervals in a circumferential direction around the center hole 22 and extend in the radial directions of the guide bracket 20 respectively. Specifically, the guide walls 25 are in pairs and radially extend in four directions from the center hole 22 serving as the center. Consequently, four pairs of guide walls 25 respectively guide the four lock gears 60A to 60D in the radial directions of the guide bracket 20.

The internal gear 30 is configured to be fixedly attached to a lower portion of a frame 3a (specifically, a side frame, see FIG. 1 to FIG. 2) of the seatback 3 serving as the other of the frame of the seat cushion 2 and the frame of the seatback 3, while facing the guide bracket 20.

As illustrated in FIG. 3, FIG. 6A, and FIG. 6B, the internal gear 30 includes a recess 31 having a circular shape in an axial view of the internal gear 30 and a substantially recessed shape in cross-section. The recess 31 has an inner circumferential surface 31a formed with the internal teeth 32 over the entire circumference of the inner circumferential surface 31a. The internal teeth 32 protrude from the inner circumferential surface 31a toward the rotation center of the internal gear 30. The internal gear 30 is arranged in such a manner that a bottom surface 31b defining the recess 31 faces the inner surface 21b (facing surface) of the main body 21 of the guide bracket 20. The recess 31 has a through hole 33 at the center thereof. As illustrated in FIG. 2, the through hole 33 is aligned with a through hole 3b of the frame 3a of the seatback 3. The end of the connecting rod 7 and the end of the associated resin bush 8 are inserted in the reclining mechanism 6 through the through hole 33.

As illustrated in FIG. 3 and FIG. 6B, a peripheral edge portion defining the recess 31 is fitted to a bulge 26 of the guide bracket 20, that is, fitted to the bulge 26 defined between the main body 21 and the flange 24 as illustrated in FIG. 6B, in a state where the guide bracket 20 and the recess 31 of the internal gear 30 face each other. This determines a radial position of the internal gear 30 relative to the guide bracket 20.

Besides, the attachment ring 70 is fixedly attached to the flange 24 by welding or other way to prevent the internal gear 30 from coming off in the axial direction. In this manner, the internal gear 30 is connected to the guide bracket 20 rotatably relative thereto.

As illustrated in FIG. 3, the four lock gears 60A to 60D are members (i.e., lock plates) each having the external teeth 63 configured to mesh with the associated internal teeth 32 of the internal gear 30, and having a substantially rectangular shape in a plan view. The lock gears 60A to 60D are arranged to be movable along the inner surface 21b of the guide bracket 20 while being guided by the guide walls 25 on the inner surface 21b in the radial directions of the guide bracket 20. This enables each of the lock gears 60A to 60D to shift between the meshing position where the external teeth 63 and the internal teeth 32 mesh and the release position where the meshing is released. Each of the lock gears 60A to 60D has a groove to be engaged 61 cut out into a substantially arc shape to extend in a circumferential direction of the cam 50 at an inner circumferential surface of the lock gear. The groove to be engaged 61 is a groove to be engaged with an engaging protrusion 52 of the cam 50 to be described later. Further, owing to the groove to be engaged 61 extending in the circumferential direction, each of the lock gears 60A to 60D has a substantially L-shaped engagement protrusion 64 along the inner circumferential surface thereof at an inner position than the groove to be engaged 61 in the radial direction of the guide bracket 20. In other words, the L-shaped engagement protrusion 64 serves to engage with the engaging protrusion 52 of the cam 50.

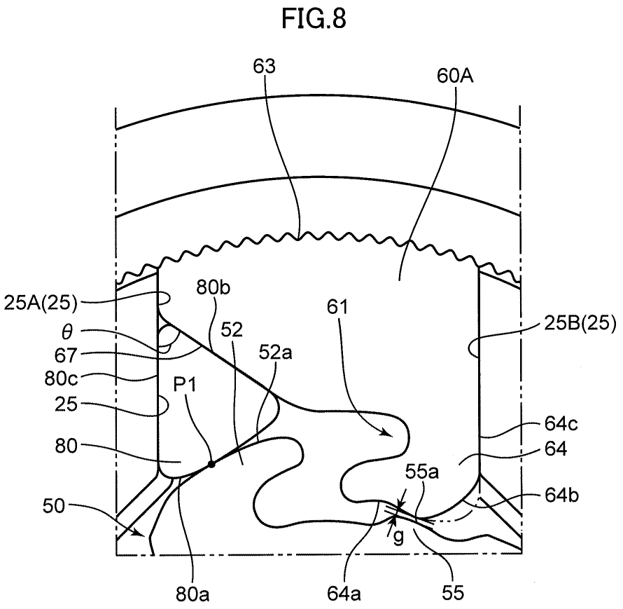

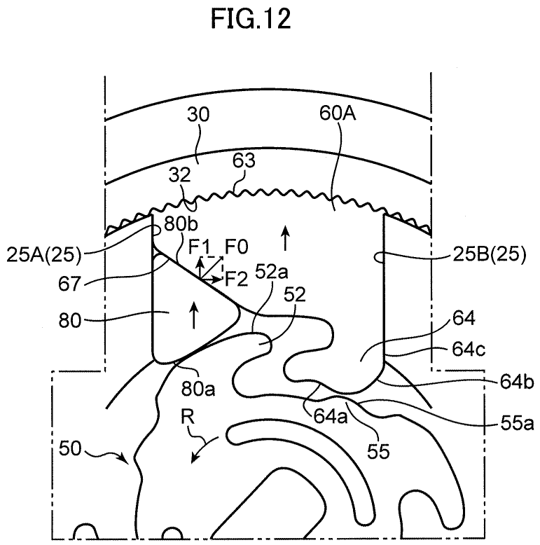

As illustrated in FIG. 8 to FIG. 12, the L-shaped engagement protrusion 64 has: an outer face 64a facing the cam 50 on a radially inside of the guide bracket 20; a groove to be engaged 61 to be engaged with the engaging protrusion 52 of the cam 50 at an inner position of the L-shaped engagement protrusion 64; a corner 64b at an outer position of the L-shaped engagement protrusion 64, i.e., opposite to the groove to be engaged 61; and a side face 64c facing a guide wall 25B of the guide bracket 20. The outer face 64a faces a bulge 55 of the cam 50 at a distance therefrom in the locking state (meshing position) of the main lock gear 60A, 60C (see FIG. 12). The corner 64b is defined by the outer face 64a and the side face 64c at the outer position of the L-shaped engagement protrusion 64. The corner 64b results from chamfering to avoid contact with the bulge 55 during rotation of the cam 50 from the release position to the meshing position. Specifically, the corner 64b results from chamfering to remove a portion protruding radially inward as denoted by a long dashed double-short dashed line in FIG. 8 and form an arc or a line into the shape denoted by a solid line in FIG. 8.

As illustrated in FIG. 3 and FIG. 7, the pair of main lock gears 60A, 60C face each other and align in an up-down direction across the cam 50.

The pair of sub-lock gears 60B, 60D are at an angle of 90° to the pair of main lock gears 60A, 60C in the circumferential direction of the cam 50, and face each other and align across the cam 50.

As illustrated in FIG. 3 and FIG. 7 to FIG. 8, the pair of main lock gears 60A, 60C radially facing each other and aligning in the up-down direction each has the external teeth 63 and the engagement protrusion 64 in common with the sub-lock gears 60B, 60D, but differ from the sub-lock gears in each having a wedge contact face 67 shown in FIG. 8.

The wedge contact face 67 is a slope extending in an inclined direction with respect to the radial direction on the inner circumference of the main lock gear 60A, 60C, and is in contact with the wedge 80. The wedge contact face 67 is circumferentially adjacent to the engagement protrusion 64. Specifically, the wedge contact face 67 is located closer to one guide wall 25A of the pair of guide walls 25A, 25B, and the engagement protrusion 64 is located closer to the other guide wall 25B.

In the embodiment, the wedge 80 has a substantially triangular and pointed wedge shape, and is sandwiched between the wedge contact face 67 of the main lock gear 60A, 60C and the guide wall 25, more specifically, the guide wall 25A closer to the wedge 80 in FIG. 8.

As illustrated in FIG. 8 to FIG. 9, the wedge 80 has a contact face 80a having an arc shape and being in contact with the cam 50 (specifically, a pushing face 52a having an arc shape and constituting an outer circumferential face of the engaging protrusion 52 to be described later), a guide wall contact face 80c being in contact with the guide wall 25A, and a lock gear contact face 80b being in contact with the wedge contact face 67 of the main lock gear 60A, 60C.

As illustrated in FIG. 8, the guide wall contact face 80c and the lock gear contact face 80b define an angle θ therebetween to fall within a range from 30° to 70° in a rotational axial view of the cam 50 (in a direction perpendicular to the sheet of FIG. 8) as an angle required for the wedge 80 to press the main lock gear 60A, 60C toward the guide wall 25B opposite to the wedge 80 with a sufficient pressing force.

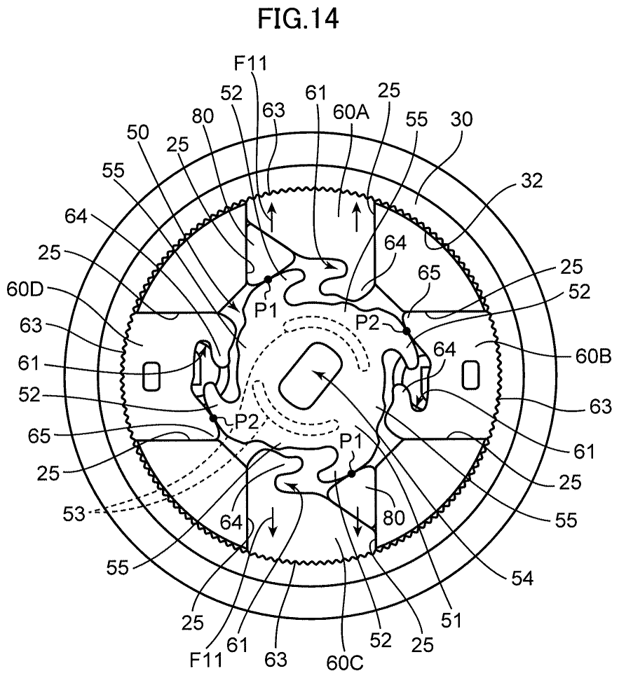

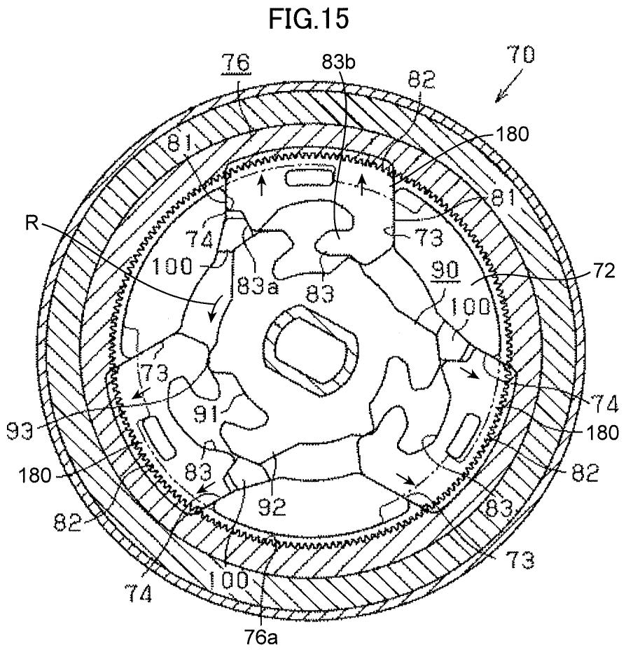

The pair of sub-lock gears 60B, 60D differ from the main lock gears 60A, 60C in such a shape as integrated with a wedge 80. Specifically, as illustrated in FIG. 3, FIG. 7, and FIG. 14, the sub-lock gear 60B, 60D has a protrusion 65 corresponding to the wedge 80 and protruding radially inward on a radially inside of the sub-lock gear. The protrusion 65 has a radially inner face configured to come into contact with the cam 50, specifically, with the pushing face 52a having an arc shape constituting the outer circumferential face of the engaging protrusion 52.

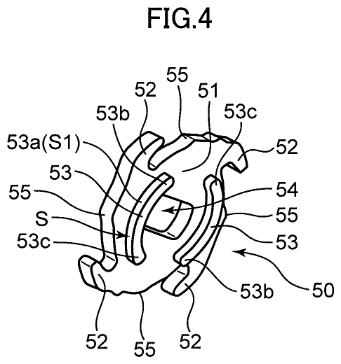

The cam 50 is rotatable relative to the guide bracket 20 between a predetermined locking angle and an unlocking angle. As illustrated in FIG. 3 to FIG. 4, and FIG. 6B, the cam 50 has a main body 51, and a shaft part S protruding from the main body 51 toward the guide bracket 20 in the axial direction of the cam 50 and located in the center hole 22 of the guide bracket 20.

The main body 51 has four engaging protrusions 52 serving as a plurality of operative parts to radially move the four lock gears 60A to 60D respectively. The four engaging protrusions 52 extend in such directions as to be engageable respectively with the grooves to be engaged 61 (see FIG. 3) of the four lock gears 60A to 60D, more specifically, extend in a substantially arc at an angle (in a substantially L-shape) and at equal intervals in the circumferential direction.

As illustrated in FIG. 7 to FIG. 8, the cam 50 has four pushing faces 52a that respectively come into direct or indirect contact with the four lock gears 60A to 60D in association with rotation from the unlocking angle to the locking angle with a rotational urging force of each lock spring 40 and respectively push and move the four lock gears outward in the radial directions of the cam 50 to the meshing positions. The four pushing faces 52a respectively constitute the outer circumferential faces of the four engaging protrusions 52. A pair of the pushing faces 52a aligned in the up-down direction are respectively in contact with the wedges 80 being adjacent to the pair of main lock gears 60A, 60C; and rest of the pushing faces 52a respectively come into contact with the protrusions 65 of the pair of sub-lock gears 60B, 60D to push and move all the lock gears 60A to 60D radially outward from the cam 50 to the meshing positions. Each pushing face 52a contains a curve in an arc.

Specifically, each of the two pushing faces 52a respectively being in contact with the wedges 80 among the four pushing faces 52a serves as a wedge pushing part that pushes the wedge 80 radially outward while maintaining a state of contact with the wedge 80 during movement of the main lock gear 60A, 60C from the release position to the meshing position. Each of the remaining two pushing faces 52a serves as a protrusion pushing part that pushes the protrusion 65 radially outward while maintaining a state of contact with the protrusion 65 during movement of the sub-lock gear 60B, 60D from the release position to the meshing position.

Further, the cam 50 has the bulge 55 in each portion between adjacent engaging protrusions 52 among the four engaging protrusions 52 on the outer circumferential surface thereof. Each of the two bulges 55 among the four bulges 55 constitutes a lock gear facing part that faces the main lock gear 60A, 60C while keeping a gap g between the lock gear facing part and the main lock gear 60A, 60C (specifically, the engagement protrusion 64) during the movement of the main lock gear 60A, 60C from the release position to the meshing position. Each of the remaining two bulges 55 constitutes a lock gear facing part that faces the sub-lock gear 60B, 60D while keeping a gap between the lock gear facing part and the engagement protrusion 64 of the sub-lock gear 60B, 60D during the movement of the sub-lock gear 60B, 60D from the release position to the meshing position.

As illustrated in FIG. 7, the four pushing faces 52a respectively have portions including contact points P1, P2 (see FIG. 7) serving as pushing portions to come into respectively contact with the four lock gears 60A to 60D at the meshing positions and keep the lock gears 60A to 60D at the meshing positions when the cam 50 is at the predetermined locking angle.

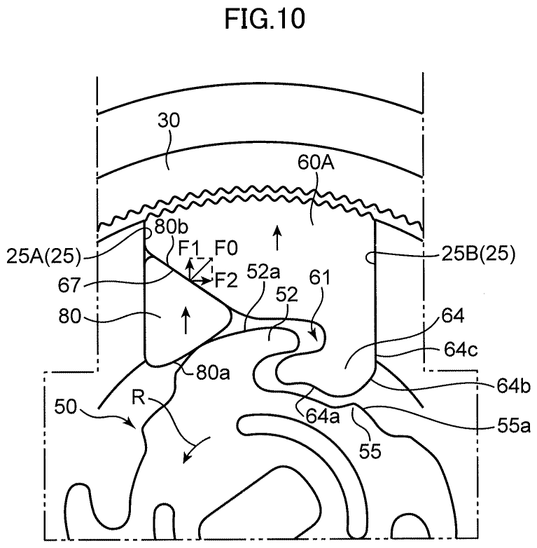

The portion including the contact point P1 as the pushing portion of the pushing face 52a is configured to push the associated wedge 80 adjacent to corresponding one of the pair of main lock gears 60A, 60C radially outward even when the cam 50 exceeds the locking angle. In the embodiment, the portion of the pushing face 52a including the contact point P1 has an arc shape, and thus is almost in point contact with the contact face 80a of the wedge 80 having the arc shape within a narrow region including the contact point P1 and a periphery therearound. Hence, even when the cam 50 exceeds the locking angle, the portion of the pushing face 52a including the contact point P1 can push the wedge 80 radially outward while being in contact with the contact face 80a having the arc shape. Here, “pushing even when the cam exceeds the locking angle” means pushing in a period from the start of meshing of the lock gear 60A, 60C until one of end faces of the main lock gear 60A, 60C in the width direction thereof located opposite the wedge 80 comes into contact with the guide wall 25B of the guide bracket 20. The portion of the pushing face 52a including the contact point P1 tilts from a contact portion of the main lock gear 60A, 60C to come into contact with the pushing portion at such an angle that the cam 50 can push the wedge 80 of the main lock gear 60A, 60C when advancing in the locking direction R (see FIG. 10 to FIG. 13) over the predetermined locking angle.

The portion of the pushing face 52a including the contact point P2 may be configured to be in contact with the protrusion 65 of the sub-lock gear 60B, 60D at the meshing position to maintain the meshing state. For instance, the portion of the pushing face 52a including the contact point P2 faces in a normal direction agreeing with the direction of the outer circumferential face of the protrusion 65 of the sub-lock gear 60B, 60D to suppress an increase in the pushing force to the sub-lock gear 60B, 60D regardless of further advancement of the cam 50 in the locking direction R over the predetermined locking angle.

The remaining configuration of the cam 50 will be described below.

As illustrated in FIG. 2 to FIG. 4, the main body 51 of the cam 50 has a rod engagement hole 54 at the center thereof. The rod engagement hole 54 receives an end of the connecting rod 7 to engage therewith through the through hole 33 of the internal gear 30. The connecting rod 7 is manually rotated to allow the cam 50 in the reclining mechanism 6 to rotate.

As illustrated in FIG. 4, the shaft part S of the cam 50 has an outer circumferential surface S1 being in contact with an inner circumferential surface 22a defining the center hole 22 of the guide bracket 20, and an engaged section (an engaged end 53b to be described later) for engagement with the outer end 41 of the lock spring 40.

In the embodiment, the shaft part S includes a plurality of protrusions 53 (two protrusions in the embodiment) axially protruding from the main body 51. The outer circumferential surface S1 includes radially outer faces 53a of the two protrusions 53 in a radial view of the cam 50. Each of the radially outer faces 53a curves in an arc in an axial view of the cam 50. Each protrusion 53 is preferably formed to have a semi-penetrating shape when the cam 50 is molded.

In the embodiment, the engaged section is defined, at each of the two protrusions 53, by the engaged end 53b being one end of the protrusion in the circumferential direction of the cam 50. The engaged end 53b is one of the opposite ends 53b and 53c of the protrusion 53 in the circumferential direction thereof, that is, an end facing in a rotation direction (clockwise direction in FIG. 4) in which the engaging protrusion 52 engages with the groove to be engaged 61 of corresponding one of the four lock gears 60A to 60D in the circumferential direction of the cam 50.

The lock spring 40 rotates and urges the cam 50 in a predetermined direction (the locking direction R of the cam 50 as shown in FIG. 10 to FIG. 13) from the unlocking angle to the locking angle by engagement of the outer end 41 of the lock spring 40 with the engaged end 53b of the protrusion 53. Specifically, as illustrated in FIG. 10 to FIG. 13, the four engaging protrusions 52 of the cam 50 push: the pair of wedges 80 that press the pair of main lock gears 60A, 60C; and the protrusions 65 of the pair of sub-lock gears 60B, 60D outward in radial directions of the cam 50, and each lock spring 40 rotates and urges the cam 50 in a direction to move each of the lock gears 60A to 60D to the meshing position where the external teeth 63 meshes with the internal teeth 32 of the internal gear 30.

The cam 50 is rotatably supported relative to the guide bracket 20 by the contact of the outer circumferential surface S1 of the shaft part S with the inner circumferential surface 22a defining the center hole 22 of the guide bracket 20.

As described above, the radial position of the cam 50 relative to the guide bracket 20 is determined by the contact of the inner circumferential surface 22a defining the center hole 22 of the guide bracket 20 with the radially outer faces 53a (i.e., the outer circumferential surface S1 of the shaft part S) of the protrusions 53.

As illustrated in FIG. 3, the two lock springs 40 are respectively accommodated in the accommodation parts 23 at the inner surface 21b of the main body 21 of the guide bracket 20 to be equally spaced around the center hole 22 in the circumferential direction, that is, the lock springs 40 are arranged at the opposite positions across the center hole 22 in the embodiment.

Each of the lock springs 40 in the embodiment is a spiral spring resulting from spirally winding a strip-shaped thin metal plate and has the outer end 41 and an inner end 42. The inner end 42 engages with an engagement protrusion (not shown) located in the associated accommodation part 23 of the guide bracket 20.

The outer end 41 engages with the engaged end 53b of the protrusion 53 of the cam 50. Such engagement allows each of the two lock springs 40 to urge the cam 50 rotatably in such a direction as to shift each of the four lock gears 60A to 60D from the release position to the meshing position.

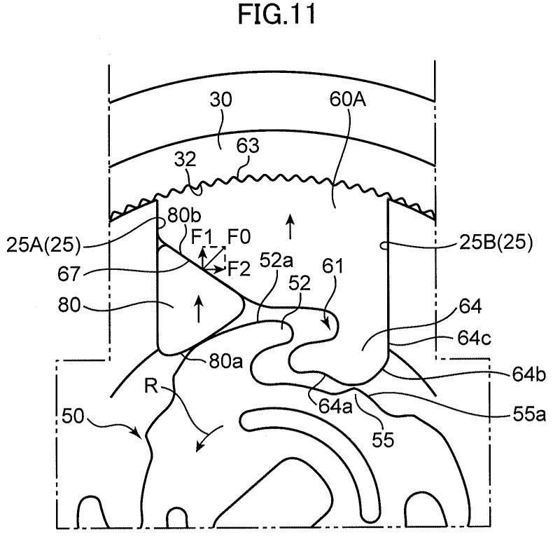

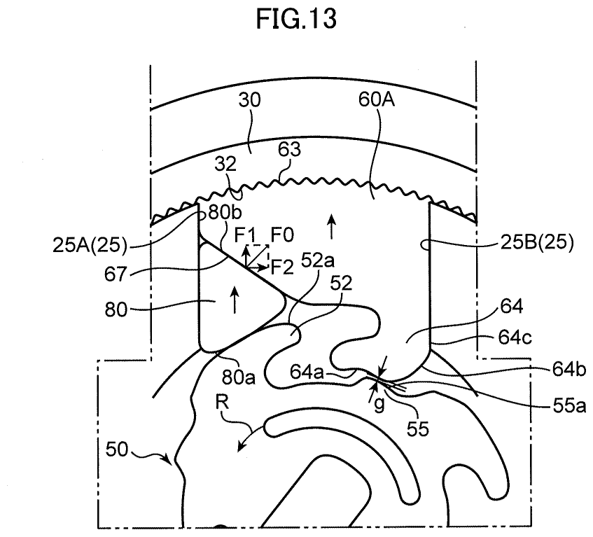

In a normal locking state in the reclining mechanism 6, as illustrated in FIG. 13 to FIG. 14, the cam 50 is urged in the locking direction R with a rotational urging force from the lock spring 40. In this state, the respective pushing faces 52a of the two engaging protrusions 52 of the cam 50 push the pair of wedges 80 respectively interposed between each of the pair of main lock gears 60A, 60C and the cam 50 to strongly push the pair of main lock gears 60A, 60C radially outward and keep each of the main lock gears at the meshing position. This configuration allows each external tooth 63 of each gear to firmly mesh with each internal tooth 32 of the internal gear 30 (see a pressing force F11 in FIG. 14) and allows the clearance to be smaller (narrower) in the width direction of the main lock gear 60A, 60C (see a divisional force F2 in FIG. 13), and thus prevents rattling. Specifically, as illustrated in FIG. 11 to FIG. 13, when the wedge contact face 67 tilting with respect to the radial direction in the main lock gear 60A, 60C receives a pressing force F0 from the wedge 80, the pressing force F0 is divided into a radial divisional force F1 and a circumferential divisional force F2. The radial divisional force F1 serves as the pressing force F11 in FIG. 14 to achieve the firm meshing of the main lock gear 60A, 60C, and the circumferential divisional force F2 prevents the rattling of the main lock gear 60A, 60C.

Each bulge 55 of the cam 50 is always kept away from the associated L-shaped engagement protrusion 64 of each of the lock gears 60A to 60D. As illustrated in FIG. 8 and FIG. 13, the gap g is kept between an outer face 55a of the bulge 55 and the outer face 64a of the L-shaped engagement protrusion 64 even in the locking state. Accordingly, the main lock gear 60A, 60C is not pressed by the cam 50, but is always pressed by the wedge 80.

In a case where a large load enters from outside of the reclining device 5 in the locking state by the lock gears 60A to 60D, the bulge 55 can come into contact with the L-shaped engagement protrusion 64 to prevent the meshing of the lock gears 60A 60D from being released.

In contrast, when the connecting rod 7 receives a rotational manipulation force, the cam 50 rotates in the opposite direction (rotates in a direction opposite to the locking direction R1 in FIG. 10 to FIG. 13) against the elastic force of each lock spring 40 to shift the four lock gears 60A to 60D toward the center. Specifically, when the cam 50 illustrated in FIG. 10 to FIG. 13 rotates in the opposite direction to the locking direction R, the four engaging protrusions 52 of the cam 50 respectively engage with the grooves to be engaged 61 (see FIG. 3) of the lock gears 60A to 60D to pull the four lock gears 60A to 60D toward the center of the cam 50. This operation pulls each of the four lock gears 60A to 60D radially inward and shifts each lock gear from the meshing position to the release position so as to be in the unlocked state. The unlocking state allows a change in the angle of the seatback 3 to any appropriate angle. No more application of the rotational manipulative force to the connecting rod 7 after the change in the angle of the seatback 3 to the preferable angle leads to restoration of the locking state with the rotational urging force of each lock spring 40.

### Characteristics of the Embodiment

(1) In the reclining mechanism 6 serving as a main structure of the reclining device 5 in the embodiment, the cam 50 has: the pushing face 52a of the engaging protrusion 52 serving as the wedge pushing part to push the wedge 80 radially outward while maintaining the state of contact with the wedge 80 during movement of the main lock gear 60A, 60C pressed by the wedge 80 from the release position to the meshing position; and the bulge 55 constituting the lock gear facing part that faces the lock gear 60A, 60C while keeping a gap between the lock gear facing part and the lock gear 60A, 60C during the movement of the lock gear 60A, 60C from the release position to the meshing position.

As illustrated in FIG. 10 to FIG. 13, this configuration maintains the state where the wedge 80 pressing the main lock gear 60A, 60C is pushed by the pushing face 52a of the engaging protrusion 52 serving as the wedge pushing part of the cam 50 during the movement of the main lock gear 60A, 60C from the release position to the meshing position.

The wedge 80 pushed radially outward by the pushing face 52a of the engaging protrusion 52 serving as the wedge pushing part of the cam 50 always presses the main lock gear 60A, 60C against the guide wall 25B of the pair of guide walls 25 that is located opposite the wedge 80 with the circumferential divisional force F2 based on the pressing force F0 that the wedge contact face 67 tilting with respect to the radial direction receives from the wedge 80. This leads to stabilization of the posture of the main lock gear 60A, 60C in the movement to the meshing position.

Besides, each lock spring 40 rotates and urges the cam 50 from the unlocking angle to the locking angle in the locking direction R even after completion of the movement of the main lock gear 60A, 60C to the meshing position. Accordingly, even after completion of the movement of the main lock gear 60A, 60C to the meshing position, the pushing face 52a of the engaging protrusion 52 of the cam 50 serving as the wedge pushing part maintains the state of pushing the wedge 80, which presses the main lock gear 60A, 60C, radially outward, and the bulge 55 constituting the lock gear facing part keeps the gap between the lock gear facing part and the lock gear 60A, 60C. In other words, the main lock gear 60A, 60C is pushed, even at the meshing position, only by the pushing face 52a serving as the wedge pushing part. This makes the main lock gear 60A, 60C less susceptible to component variation that may cause the external teeth 63 and the internal teeth 32 to mesh before contacting the cam 50. This achieves prevention of rattling of the main lock gear 60A, 60C in the locking state.

(2) As illustrated in FIG. 8, in the reclining mechanism 6 in the embodiment, the wedge 80 has the guide wall contact face 80c being in contact with the guide wall 25A, and the lock gear contact face 80b being in contact with the wedge contact face 67 of the main lock gear 60A, 60C.

The guide wall contact face 80c and the lock gear contact face 80b define the angle θ therebetween to fall within a range from 30° to 70° in a rotational axial view of the cam 50. This configuration allows the wedge 80 to continuously press the main lock gear 60A, 60C against the guide wall 25B with an enough pressing force during the movement of the main lock gear 60A, 60C from the release position to the meshing position, resulting in further stabilizing the posture of the main lock gear 60A, 60C in the movement.

(3) As illustrated in FIG. 8, in the reclining mechanism 6 in the embodiment, the lock gear facing part of the cam 50 has the bulge 55 bulging from the outer circumferential surface of the cam 50 radially outward and toward the main lock gear 60A, 60C.

The main lock gear 60A, 60C has the corner 64b at a radially inward end of the main lock gear (specifically, the corner 64b at the outer position of the L-shaped engagement protrusion 64) so as to be closest to the bulge 55 when the cam 50 is at the unlocking angle.

The corner 64b results from chamfering to avoid contact with the bulge 55 during the rotation of the cam 50 from the unlocking angle to the locking angle.

This configuration including the corner 64b resulting from chamfering on a radially inside of the main lock gear 60A, 60C allows the corner 64b to avoid contact with the bulge 55 during the rotation of the cam 50 from the unlocking angle to the locking angle even in the case where the lock gear facing part has the bulge 55 bulging radially outward and toward the main lock gear 60A, 60C.

(4) The seat 1 according to the embodiment includes the seat cushion 2, the seatback 3 located in the rear of the seat cushion 2 and being tiltable in the front-rear direction of the seat, and the reclining mechanism 6 having the above-described configuration to fixedly hold the seatback 3 at a certain tilt angle. This configuration achieves stabilization of the posture of the main lock gear 60A, 60C in the movement, and prevention of rattling of the main lock gear 60A, 60C in the locking state. This results in prevention of the rattling of the seatback 3.

### Modifications

(A) Although the embodiment exemplifies the bulge 55 constituting the lock gear facing part of the cam 50, the present invention is not limited to the bulge. The lock gear facing part in the preset invention may be configured to face the main lock gear 60A, 60C while keeping a gap between the lock gear facing part and the main lock gear 60A, 60C, and thus may be in a shape of a smooth circumferential face of the main body 51 of the cam 50 without limitation to the shape of the bulge 55.

(B) Although the embodiment shows a configuration including the four lock gears 60A to 60D as a plurality of lock gears and the pair of main lock gears 60A, 60C radially facing each other respectively have the wedges 80, the present invention is not limited to this configuration. In the present invention, at least one lock gear among the lock gears may have a wedge.

(C) Although each wedge 80 has a substantially triangular shape in the embodiment, the present invention is not limited to the triangular shape. As illustrated in FIG. 8, the wedge 80 has the contact face 80a being in contact with the pushing face 52a of the cam 50, and may have various kinds of shapes as long as the wedge can be sandwiched between the wedge contact face 67 and the guide wall 25A. The wedge in the present invention thus may have a circular shape, a trapezoidal shape, or a substantially pentagonal shape without limitation to the triangular shape. The wedge having such a shape allows the main lock gear 60A, 60C to move radially outward without rattling, while pressing the main lock gear against the guide wall 25B.

(D) Although the two lock springs 40 are equally spaced in the circumferential direction of the guide bracket 20 in the embodiment, the present invention may include at least one lock spring without limitation to the two springs. The reclining mechanism 6 therefore may be configured to include one lock spring, or three or more lock springs. Various kinds of lock springs including a plate spring, a coil spring, a rubber spring, and an air spring may be adoptable for the lock spring without limitation to the spiral spring in the embodiment.

(E) Although the guide bracket 20 is configured to be fixedly attached to the frame 2a of the seat cushion 2 and the internal gear 30 is configured to be fixedly attached to the frame 3a of the seatback 3 in the embodiment, the present invention is not limited to this arrangement. The guide bracket 20 and the internal gear 30 may be arranged the other way round. Specifically, the internal gear 30 may be fixedly attached to the frame 2a of the seat cushion 2, and the guide bracket 20 may be fixedly attached to the frame 3a of the seatback 3.

### Summary of the Embodiment

The embodiment is summarized in the following manner.

A reclining device according to the embodiment includes: a guide bracket configured to be fixedly attached to one of a frame of a seat cushion and a frame of a seatback; an internal gear configured to be fixedly attached to the other of the frame of the seat cushion and the frame of the seatback in such a manner as to face the guide bracket and be rotatable relative to the guide bracket; a plurality of lock gears each having a plurality of external teeth configured to mesh with a plurality of internal teeth of the internal gear, spaced from each other in a circumferential direction of the internal gear, and each being movable along the guide bracket in a radial direction of the guide bracket over a region between a meshing position where the external teeth and the internal teeth mesh and a release position where the meshing is released; a cam that is rotatable relative to the guide bracket between a predetermined locking angle and an unlocking angle, and configured to radially move each of the lock gears from the release position to the meshing position by rotating from the unlocking angle to the locking angle; a lock spring that rotates and urges the cam from the unlocking angle to the locking angle; and a wedge interposed between at least one lock gear among the lock gears and the cam and pressing the lock gear. The guide bracket has a plurality of pairs of guide walls facing each other and configured to radially guide the lock gears. At least one of the lock gear pressed by the wedge has a wedge contact face extending in an inclined direction with respect to the radial direction and being in contact with the wedge. The wedge is sandwiched between the wedge contact face and an associated guide wall among the guide walls. The cam has: a wedge pushing part configured to push the wedge radially outward while maintaining a state of contact with the wedge during movement of the lock gear from the release position to the meshing position; and a lock gear facing part that faces the lock gear while keeping a gap between the lock gear facing part and the lock gear pressed by the wedge during the movement of the lock gear from the release position to the meshing position.

In this configuration, the cam has: the wedge pushing part to push the wedge radially outward while maintaining the state of contact with the wedge during movement of the lock gear from the release position to the meshing position; and the lock gear facing part that faces the lock gear while keeping a gap between the lock gear facing part and the lock gear during the movement of the lock gear from the release position to the meshing position. This configuration maintains the state where the wedge pushing part pushes the wedge during the movement of the lock gear from the release position to the meshing position.

As the wedge is pushed radially outward by the wedge pushing part, the lock gear is always pressed against the guide wall of the pair of guide walls that is located opposite the wedge with a circumferential divisional force based on a pressing force that the wedge contact face tilting with respect to the radial direction receives from the wedge. This leads to stabilization of the posture of the lock gear in the movement to the meshing position.

Besides, the lock spring rotates and urges the cam from the unlocking angle to the locking angle even after completion of the movement of the lock gear to the meshing position. Accordingly, even after completion of the movement of the lock gear to the meshing position, the wedge pushing part of the cam maintains the state of pushing the wedge radially outward, and the lock gear facing part keeps the gap between the lock gear facing part and the lock gear. In other words, the lock gear is pushed, even at the meshing position, only by the wedge pushing part of the cam. Thus, the lock gear is less likely to be influenced by variation in components. This configuration achieves prevention of rattling of the lock gear in the locking state.

The configuration allows the wedge to continuously press the lock gear toward the guide wall with an enough pressing force during the movement of the lock gear from the release position to the meshing position, resulting in further stabilizing the posture of the lock gear in the movement.

In the reclining device, preferably, the lock gear facing part has a bulge bulging from an outer circumferential surface of the cam radially outward and toward the lock gear, and the lock gear has a corner at a radially inward end of the lock gear so as to be closest to the bulge when the cam is at the unlocking angle, the corner resulting from chamfering.

This configuration including the corner resulting from chamfering on a radially inside of the lock gear allows the corner to avoid contact with the bulge during the rotation of the cam from the unlocking angle to the locking angle even in the case where the lock gear facing part has the bulge bulging radially outward and toward the main lock gear.

A seat according to the present invention includes: a seat cushion; a seatback located in the rear of the seat cushion and being tiltable in a front-rear direction of the seat; and the reclining device to fixedly hold the seatback at a certain tilt angle.

The seat including the above-described reclining device is able to stabilize the posture of the lock gear in movement and to prevent rattling of the lock gear in the locking state. This results in prevention of the rattling of the seatback.

Each of the reclining device and the seat according to the present invention is able to stabilize the posture of the lock gear in movement and to prevent the rattling of the lock gear in the locking state.

1. A reclining device, comprising:
a guide bracket configured to be fixedly attached to one of a frame of a seat cushion and a frame of a seatback;
an internal gear configured to be fixedly attached to the other of the frame of the seat cushion and the frame of the seatback in such a manner as to face the guide bracket and be rotatable relative to the guide bracket;
a plurality of lock gears each having a plurality of external teeth configured to mesh with a plurality of internal teeth of the internal gear, spaced from each other in a circumferential direction of the internal gear, and each being movable along the guide bracket in a radial direction of the guide bracket over a region between a meshing position where the external teeth and the internal teeth mesh and a release position where the meshing is released;
a cam that is rotatable relative to the guide bracket between a predetermined locking angle and an unlocking angle, and configured to radially move each of the lock gears from the release position to the meshing position by rotating from the unlocking angle to the locking angle;
a lock spring that rotates and urges the cam from the unlocking angle to the locking angle; and
a wedge interposed between at least one lock gear among the lock gears and the cam and pressing the lock gear, wherein
the guide bracket has a plurality of pairs of guide walls facing each other and configured to radially guide the lock gears,
at least one of the lock gears pressed by the wedge has a wedge contact face extending in an inclined direction with respect to the radial direction and being in contact with the wedge,
the wedge is sandwiched between the wedge contact face and an associated guide wall among the guide walls, and
the cam has:
a wedge pushing part configured to push the wedge radially outward while maintaining a state of contact with the wedge during movement of the lock gear from the release position to the meshing position; and
a lock gear facing part that faces the lock gear while keeping a gap between the lock gear facing part and the lock gear pressed by the wedge during the movement of the lock gear from the release position to the meshing position.

2. The reclining device according to claim 1, wherein the lock gear facing part has a bulge bulging from an outer circumferential surface of the cam radially outward and toward the lock gear, and
the lock gear has a corner at a radially inward end of the lock gear so as to be closest to the bulge when the cam is at the unlocking angle,
the corner resulting from chamfering.

3. A seat, comprising:
a seat cushion;
a seatback located in the rear of the seat cushion and being tiltable in a front-rear direction of the seat; and
the reclining device according to claim 1 to fixedly hold the seatback at a certain tilt angle.
